(19) United States
(12) Patent Application Publication
(10) Pub. No.: US 2026/0239216 A1
(43) Pub. Date: Aug. 13, 2026

(54) TRIGGERING A LOW POWER RECEIVER

(71) Applicant: Samsung Electronics Co., Ltd., Suwon-si (KR)

(72) Inventor: Hongbo Si, Allen, TX (US)

(21) Appl. No.: 19/645,587

(22) Filed: Apr. 13, 2026

Related U.S. Application Data
(63) Continuation of application No. 18/409,647, filed on Jan. 10, 2024, now abandoned.
(60) Provisional application No. 63/610,616, filed on Dec. 15, 2023.
(60) Provisional application No. 63/442,026, filed on Jan. 30, 2023.
(60) Provisional application No. 63/441,115, filed on Jan. 25, 2023.

(51) Int. Cl. H04W 52/02; H04L 5/00; H04W 72/232

(52) U.S. Cl. CPC H04W 52/0235; H04L 5/0053; H04W 72/232

(57) ABSTRACT

Methods and apparatuses for triggering a low-power receiver (LR). A method of a user equipment (UE) in a wireless communication system is provided. The method includes receiving a physical downlink control channel (PDCCH); determining, based on the PDCCH, a downlink control information (DCI) format including an indication on whether to activate a LR to receive a low-power wake up signal (LP-WUS); determining, based on the indication in the DCI format, to activate the LR; determining monitoring occasions for the LP-WUS; and receiving the LP-WUS based on the monitoring occasions.

### CROSS-REFERENCE TO RELATED APPLICATION AND CLAIM OF PRIORITY

This application is a continuation of U.S. Application No. 18/409,647 filed on January 10, 2024, which claims priority under 35 U.S.C. § 119(e) to U.S. Provisional Patent Application No. 63/441,115 filed on January 25, 2023, U.S. Provisional Patent Application No. 63/442,026 filed on January 30, 2023, and U.S. Provisional Patent Application No. 63/610,616 filed on December 15, 2023. The above-identified provisional patent applications is hereby incorporated by reference in its entirety.

### TECHNICAL FIELD

The present disclosure relates generally to wireless communication systems and, more specifically, relates to a method and apparatus for triggering a low-power receiver (LR).

### BACKGROUND

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

This disclosure relates to triggering a LR.

In an embodiment, a user equipment (UE) in a wireless communication system is provided. The UE includes a transceiver configured to receive a physical downlink control channel (PDCCH); a LR; and a processor operably coupled to the transceiver and the LR. The processor is configured to determine, based on the PDCCH, a downlink control information (DCI) format including an indication on whether to activate the LR to receive a low-power wake up signal (LP-WUS); determine, based on the indication in the DCI format, to activate the LR; and determine monitoring occasions for the LP-WUS. The LR is configured to receive the LP-WUS based on the monitoring occasions.

In another embodiment, a base station (BS) in a wireless communication system is provided. The BS includes a processor configured to determine a DCI format including an indication on whether to activate a LR and transmit a LP-WUS and determine monitoring occasions for the LP-WUS. The BS further includes a transceiver operably coupled to the processor. The transceiver is configured to transmit a PDCCH including the DCI format and transmit the LP-WUS based on the monitoring occasions for the LP-WUS.

In yet another embodiment, a method of a UE in a wireless communication system is provided. The method includes receiving a PDCCH; determining, based on the PDCCH, a DCI format including an indication on whether to activate a LR to receive a LP-WUS; determining, based on the indication in the DCI format, to activate the LR; determining monitoring occasions for the LP-WUS; and receiving the LP-WUS based on the monitoring occasions.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example base station according to embodiments of the present disclosure;

FIG. 3 illustrates an example user equipment (UE), according to embodiments of the present disclosure;

FIGS. 4A-B illustrate example wireless transmit and receive paths, according to embodiments of the present disclosure;

FIG. 5 illustrates a diagram of explicitly triggering a LR, according to embodiments of this disclosure;

FIG. 6 illustrates a diagram of application delays, according to embodiments of this disclosure;

FIG. 7 illustrates a flowchart for an example method for a UE for triggering a LR according to embodiments of this disclosure;

FIG. 8 illustrates a diagram of a DRX for LR, according to embodiments of this disclosure;

FIG. 9 illustrates a diagram of a UE reception in a DRX cycle, according to embodiments of this disclosure;

FIG. 10 illustrates a diagram of extending an active portion of a DRX cycle, according to embodiments of this disclosure;

FIG. 11 illustrates a diagram of shortening an active portion of a DRX cycle, according to embodiments of this disclosure;

FIG. 12 illustrates a flowchart of an example method implemented by a UE based on LRD-DRX, according to embodiments of this disclosure.

### DETAILED DESCRIPTION

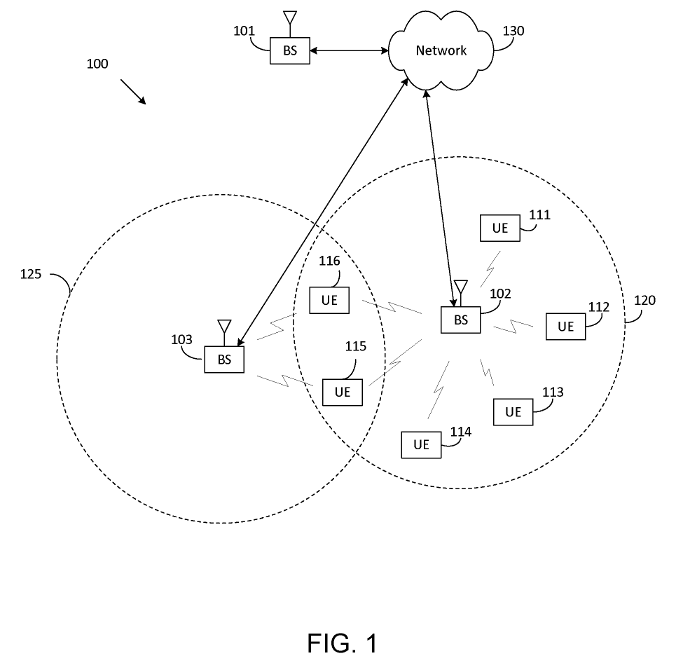

FIGS. 1 through 12, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably-arranged system or device.

The following documents and standards descriptions are hereby incorporated by reference into the present disclosure as if fully set forth herein.: 3GPP TS 38.211 v16.6.0, “NR; Physical channels and modulation” (REF1); 3GPP TS 38.212 v16.6.0, “NR; Multiplexing and Channel coding” (REF2); 3GPP TS 38.213 v16.6.0, “NR; Physical Layer Procedures for Control” (REF3); 3GPP TS 38.214 v16.6.0, “NR; Physical Layer Procedures for Data” (REF4); and 3GPP TS 38.331 v16.6.0, “NR; Radio Resource Control (RRC) Protocol Specification” (REF5).

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof to support triggering a LR. In certain embodiments, one or more of the BSs 101-103 include circuitry, programing, or a combination thereof to trigger a LR.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

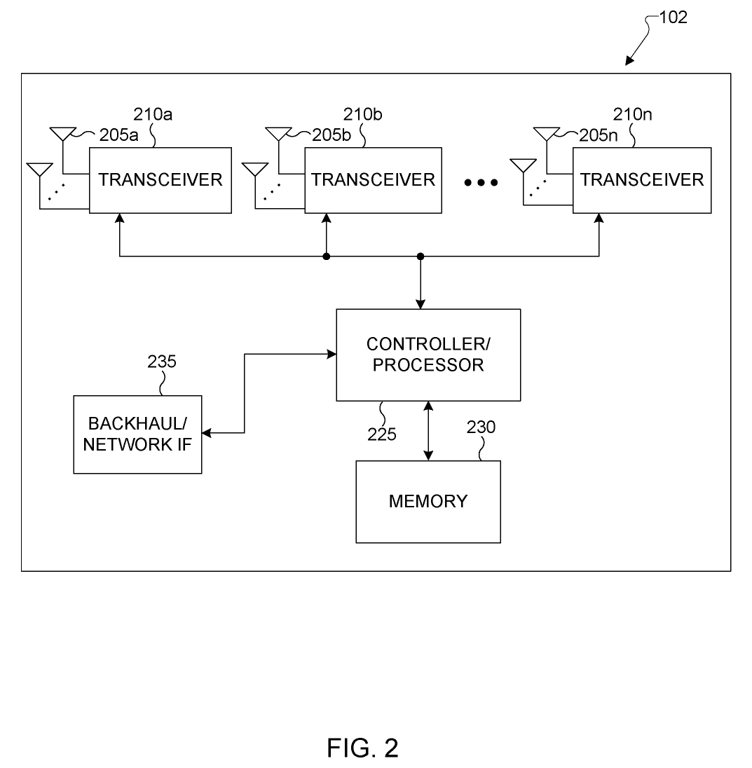

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235. The gNB 102, via the controller or processor 225, may support triggering a LR and DRX of a LR in accordance with various embodiments of this disclosure.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as processes to trigger a LR as discussed in greater detail below. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

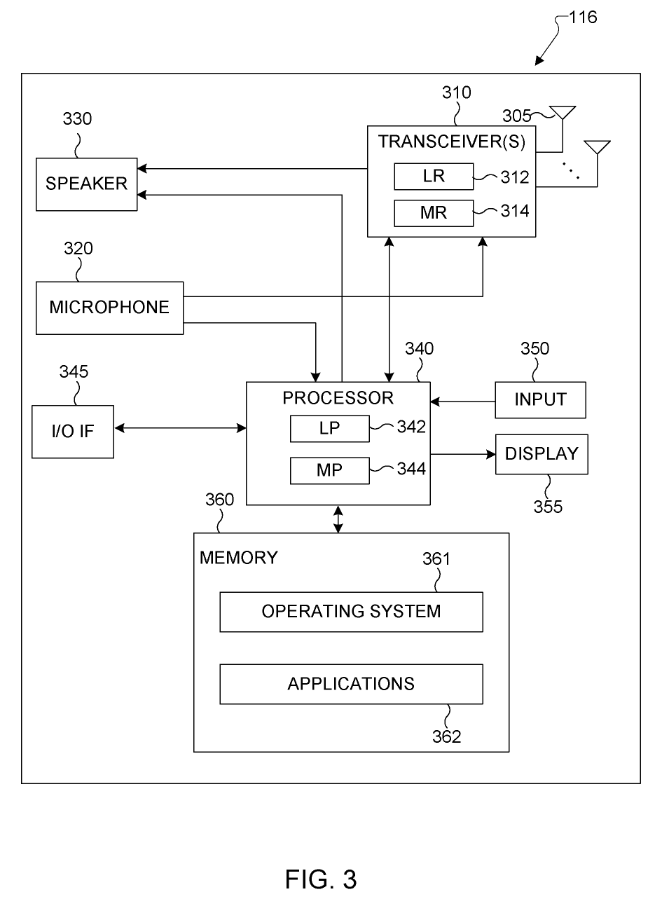

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362. In embodiments of this disclosure, the gNB 102 may support methods and an apparatus for triggering a LR, via the antenna(s) 305, transceiver(s) 310 and the processor 340.

The transceiver(s) 310 receives from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360. For example, as discussed in greater detail below, the processor 340 may execute processes to support triggering a LR. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

In various embodiments, the transceiver(s) 310 include or are at least one LR 312 and at least one main receiver (MR) 314. For example, as discussed in greater detail below, the LR 312 may be configured or utilized to receive low power signals (e.g., a LP-WUS), for example, when the UE 116 is in a sleep state (e.g., such as an ultra-deep sleep state as discussed in greater detail below), while the MR 314 is powered off or in a low power state. For example, in some embodiments, the LR 312 may be a component of the transceiver(s) 310 used or powered on when the UE 116 is in the sleep state while the MR 314 is the transceiver(s) 310 and used when the UE 116 is not in the sleep state. In another example, in other embodiments, the LR 312 may be receiver that is separate or discrete from the transceivers(s) 310 which is the MR 314 used for ordinary reception operations when the UE 116 is not in the sleep state.

Analogously, in such embodiments, the processor 340 includes or is at least one of the low-power processor (LP) 342 and the main processor (MP) 344. For example, in some embodiments, the LR 312 and the MR 314 may be connected to and/or be controlled by the LP 342 and the MP 344, respectively, which are separate and/or discrete processors. In these embodiments, the LP 342 may operate at a lower power state than the MP 344 such that, when the UE is in the sleep state, the MP 344 may be powered off or in a low power state while the LP 342 can process any signals (e.g., such as a LP-WUS) received by the LR 312. In these embodiments, the operation of the LP 342 may consume less power than ordinary operations of the MP 344 would, thereby saving power of the UE 116 in the sleep state while maintaining the ability of the UE 116 to receive and process signals. In other embodiments, the LP 342 and the MP 344 may be components of the processor 340 where the LR 312 and the MR 314 may be connected to and/or be controlled by the LP 342 and the MP 344, respectively. In these embodiments, when the UE 116 is in the sleep state, MP 344 components of the processor 340 are powered off or in a low power state and LP 342 components operate to process signals (e.g., such as a LP-WUS) received by the LR 312. In these embodiments, the operation of the LP 342 components of the processor 340 may consume less power than ordinary operations of the processor 340 including the operations of the MP 344 components would, thereby saving power of the UE 116 in the sleep state while maintaining the ability of the UE 116 to receive and process signals.

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

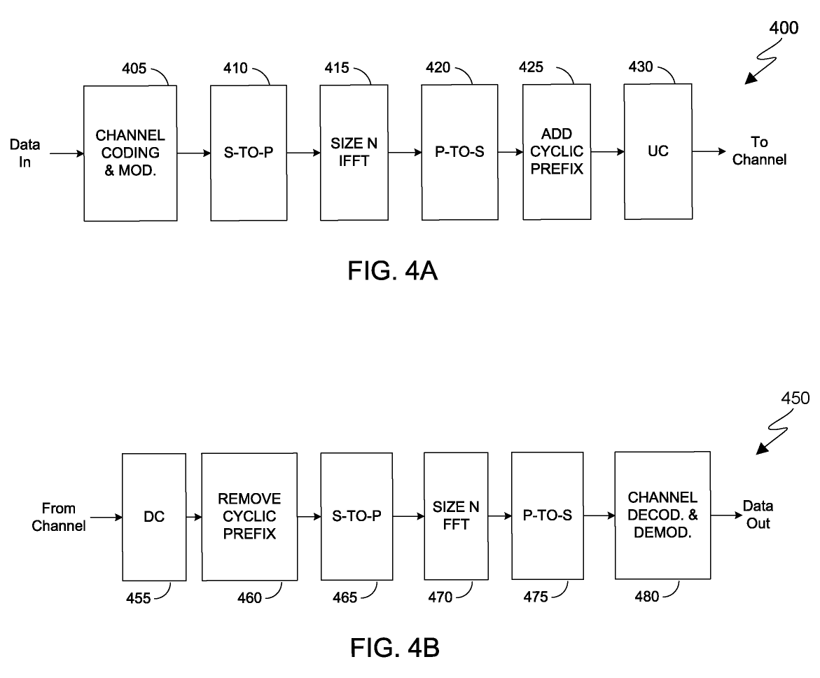

FIGS. 4A and 4B illustrate example wireless transmit and receive paths according to this disclosure. In the following description, a transmit path 400 may be described as being implemented in an gNB (such as gNB 104), while a receive path 450 may be described as being implemented in a UE (such as UE 116). However, it will be understood that the receive path 450 can be implemented in an gNB and that the transmit path 400 can be implemented in a UE.

The transmit path 400 includes a channel coding and modulation block 405, a serial-to-parallel (S-to-P) block 410, a size N Inverse Fast Fourier Transform (IFFT) block 415, a parallel-to-serial (P-to-S) block 440, an add cyclic prefix block 445, and an up-converter (UC) 430. The receive path 450 includes a down-converter (DC) 455, a remove cyclic prefix block 460, a serial-to-parallel (S-to-P) block 465, a size N Fast Fourier Transform (FFT) block 470, a parallel-to-serial (P-to-S) block 475, and a channel decoding and demodulation block 480. In embodiments, the transmit path 400 and the receive path 450 are each configured to support triggering a LR.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB 104 and the UE 116. The size N IFFT block 415 performs an IFFT operation on the N parallel symbol streams to generate time-domain output signals. The parallel-to-serial block 440 converts (such as multiplexes) the parallel time-domain output symbols from the size N IFFT block 415 in order to generate a serial time-domain signal. The add cyclic prefix block 445 inserts a cyclic prefix to the time-domain signal. The up-converter 430 modulates (such as up-converts) the output of the add cyclic prefix block 445 to an RF frequency for transmission via a wireless channel. The signal may also be filtered at baseband before conversion to the RF frequency.

A transmitted RF signal from the gNB 104 arrives at the UE 116 after passing through the wireless channel, and reverse operations to those at the gNB 104 are performed at the UE 116. The down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time domain signals. The size N FFT block 470 performs an FFT algorithm to generate N parallel frequency-domain signals. The parallel-to-serial block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 4, 3, 4, or the like) for DFT and IDFT functions, while the value of the variable N may be any integer number that is a power of two (such as 1, 4, 4, 8, 16, or the like) for FFT and IFFT functions.

Although FIGS. 4A and 4B illustrate examples of wireless transmit and receive paths, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

NR supported discontinuous reception (DRX) for a UE in either RRC_IDLE/RRC_INACTIVE mode or RRC_CONNECTED mode, such that the UE could stop receiving signals or channels during the inactive period within the DRX cycle and save power consumption. In Rel-16, enhancement towards DRX for RRC_CONNECTED mode (e.g., C-DRX) was introduced, wherein a new DCI format was used to help the UE to skip a ON duration within a C-DRX cycle such that further power saving gain could be achieved. In Rel-17, enhancement towards DRX for RRC_IDLE/RRC_INACTIVE mode (e.g., I-DRX) was introduced, wherein a paging early indication (PEI) was used for a UE to skip monitoring paging occasions such that extra power saving gain could be achieved.

However, as this disclosure recognizes, the UE still needs to frequently wake up to monitor the new DCI format or the PEI, such that the radio of the UE cannot be fully turned off for a long duration. To avoid such situation and to acquire further power saving gain, an additional receiver radio is considered, wherein the additional receiver radio can be used to monitor a particular set of signals with a very low power consumption, and the main receiver radio can be turned off or operated with very low power for a long duration.

This disclosure provides a triggering mechanism for transitioning from using a main receiver to using an additional receiver with low power, wherein a UE expects the availability of low power signal(s). For example, a low power wake up signal and/or a low power synchronization signal. The UE may also expect to receive the low power signal(s). This disclosure further provides a method and apparatus for a UE to trigger a LR or DRX of a LR in RRC_IDLE and/or RRC_INACTIVE and/or RRC_CONNECTED modes.

This disclosure also provides a triggering mechanism for a receiver to receive the low power signal(s). As will be described in more detail below, this disclosure provides (1) a triggering mechanism that is (a) an explicit trigger using a signal or channel or (b) an implicit trigger without using an explicit signal or channel; an application delay (a) for the main receiver, (b) for the LR, (c) an RRM measurement relaxation based on the application delays, and (d) an extension of application delay(s); and an example UE procedure for triggering the LR.

This disclosure also provides a DRX configuration for a LR, a reception based on the DRX configuration, an active portion extension based on the UE’s reception using LR, an active portion truncation based on the UE’s reception using LR, and an example UE procedure for DRX operation for the LR.

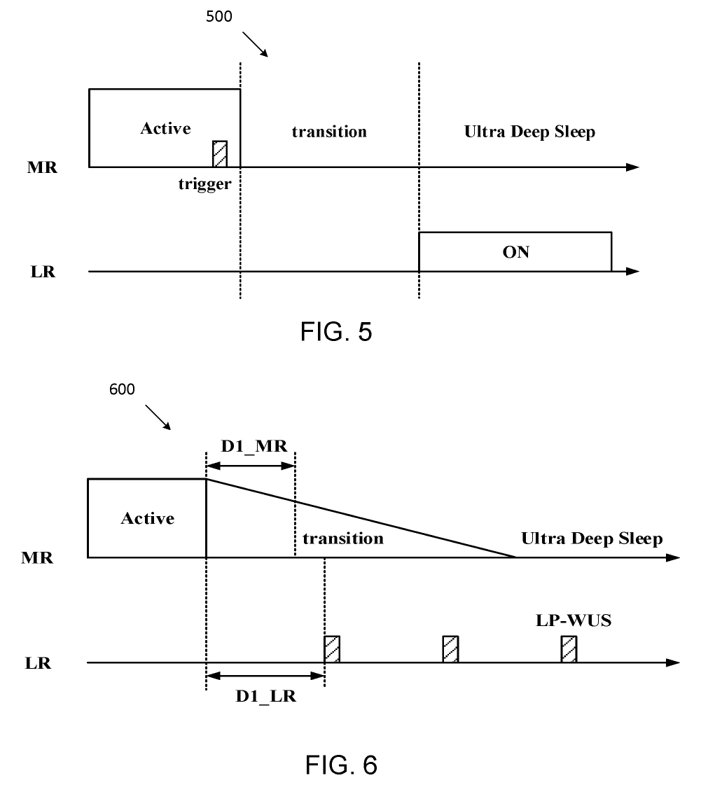

FIG. 5 illustrates a diagram 500 of explicitly triggering a LR. The embodiment of the diagram 500 illustrated in FIG. 5 is for illustration only. One or more components illustrated in FIG. 5 can be implemented in specialized circuitry configured to perform the noted functions or one or more of the components can be implemented by one or more processors executing instructions to perform the noted functions. FIG. 5 does not limit the scope of this disclosure to any particular implementation of the diagram 500 for explicitly triggering the LR.

In one embodiment, an explicit signal or channel can trigger the transition from using a MR (e.g., such as MR 314) to using a LR (e.g., such as LR 312), or trigger the use of the LR, or trigger the MR to operate in a state with low power (e.g., ultra deep sleep), or trigger the activation and/or deactivation of low-power signal(s) (e.g., low power wake-up-signal and/or low power synchronization signal) that can be received by the LR.

In one example, the explicit signal or channel can be received by the MR.

In some examples, if the UE is in RRC_CONNECTED mode, the UE can transit to RRC_IDLE or RRC_INACTIVE mode after receiving the explicit signal or channel.

In more examples, if the UE is in RRC_INACTIVE mode, the UE can transit to RRC_IDLE mode after receiving the explicit signal or channel.

In additional examples, the explicit signal or channel can be sent by the gNB.

In further examples, the explicit signal or channel can be a response to a request on using the LR, wherein the request can be sent from the UE. The request may be included in one or more of a variety of manners. The request can be included in a Msg1 of a 4-step RACH procedure (e.g., PRACH). The request can be included in a Msg3 of a 4-step RACH procedure. The request can be included in a MsgA of a 2-step RACH procedure. The request can be included in a scheduling request (SR). The request can be included in a PUCCH. The request can be included in a PUSCH (e.g., CG-PUSCH). The request can be included in higher layer parameter, e.g., UE assistant information.

In one example, the explicit signal or channel can be cell-specific.

In another example, the explicit signal or channel can be UE-group-specific.

In yet another example, the explicit signal or channel can be UE-specific.

In one example, the explicit signal or channel can be a PDCCH carrying a DCI format. The explicit signal or channel may alternatively be one or more of the following. It can be a PDCCH carrying a DCI format 1_0, wherein the PDCCH is monitored in a CSS and the DCI format 1_0 is with CRC scrambled by C-RNTI or CS-RNTI or MCS-C-RNTI. It can be a PDCCH carrying a DCI format 1_0, wherein the PDCCH is monitored in a CSS and the DCI format 1_0 is with CRC scrambled by P-RNTI. For one instance, the information carried by the PDCCH can be paging short message. It can be a PDCCH carrying a DCI format 1_0, wherein the PDCCH is monitored in a CSS and the DCI format 1_0 is with CRC scrambled by SI-RNTI. It can be a PDCCH carrying a DCI format 1_0, wherein the PDCCH is monitored in a CSS and the DCI format 1_0 is with CRC scrambled by RA-RNTI or MsgB-RNTI. It can be a PDCCH carrying a DCI format 1_0, wherein the PDCCH is monitored in a CSS and the DCI format 1_0 is with CRC scrambled by TC-RNTI. It can be a PDCCH carrying a DCI format 2_0, wherein the PDCCH is monitored in a CSS and the DCI format 2_0 is with CRC scrambled by SFI-RNTI. It can be a PDCCH carrying a DCI format 2_7, wherein the PDCCH is monitored in a CSS and the DCI format 2_7 is with CRC scrambled by PEI-RNTI. It can be a PDCCH carrying a DCI format and monitored in a USS, e.g., DCI format 1_1 and/or 1_2. It can be a PDCCH carrying a DCI format (e.g., a new DCI format), wherein the PDCCH is monitored in a CSS and/or the DCI format is with CRC scrambled by at least a new RNTI.

In another example, the explicit signal or channel can be based on: a SS/PBCH block, a PSS in a SS/PBCH block, a SSS in a SS/PBCH block, DM-RS of PBCH in a SS/PBCH block, and PBCH content carried by PBCH in a SS/PBCH block. There could be an explicit indication in PBCH content on whether the LR should be triggered to be used.

In yet another example, the explicit signal or channel can be a PDSCH; a PDSCH of paging, e.g., the PDSCH scheduled by a PDCCH monitored in a paging occasion and carrying paging related information; a PDSCH carrying SIB1, e.g., the PDSCH scheduled by a type0-PDCCH; a PDSCH carrying SIBx, wherein x>1, e.g., the PDSCH scheduled by a type0A-PDCCH; a PDSCH of RAR, e.g., the PDSCH carrying Msg2 in a 4-step RACH; a PDSCH carrying Msg4 in a 4-step RACH; PDSCH carrying MsgB in a 2-step RACH; a PDSCH scheduled by a PDCCH carrying a DCI format 1_1 and/or 1_2, e.g., wherein the PDCCH is monitored in a USS; and a PDSCH carrying the RRC parameters.

In yet another example, the explicit signal or channel can be: a dedicated signal for triggering the usage of LR and/or activation/deactivation of low power signal(s); a signal generated based on a M-sequence; a signal generated based on a Gold-sequence; a signal generated based on a ZC-sequence; and a signal generated based on a PN-sequence.

In yet another example, the explicit signal or channel can be a MAC CE.

In yet another example, the explicit signal or channel can be RRC release message.

In one example, after the UE receives the explicit signal or channel, the UE can send back to the gNB a confirmation on the successful reception of the explicit signal or channel. The confirmation can be included in: a Msg1 of a 4-step RACH procedure (e.g., PRACH); a Msg3 of a 4-step RACH procedure; a MsgA of a 2-step RACH procedure; a PUCCH, e.g., a PUCCH carrying UCI; a PUSCH, e.g., a PUSCH carrying UCI; a higher layer parameter, e.g., UE assistant information; and a RRC release request. In embodiments, this example may be applicable for RRC_CONNECTED mode.

In one example, the explicit signal or channel could further include information on a time duration associated with the use of LR and/or activation/deactivation of low power signal(s). For one instance, the unit of the time duration can be a symbol, a slot, a ms, a frame, or a DRX cycle. For another instance, the reference time as the start of the time duration can be the starting instance or the ending instance of the symbol or slot where the signal or channel is received by the UE. For yet another instance, the reference time as the start of the time duration can be the starting instance or the ending instance of the symbol or slot where the confirmation on successful reception of the signal or channel is transmitted by the UE. For yet another instance, the reference time as the start of the time duration can be a delay after the symbol or slot where the signal or channel is received by the UE, wherein the delay can be provided by higher layer parameter, or fixed in the specification (e.g., according to a subcarrier spacing value), or determined based on a UE capability. For yet another instance, the reference time as the start of the time duration can be explicitly provided by the explicit signal or channel.

In another example, the explicit signal or channel could further include information on a time instance to start using the LR and/or activation/deactivation of low power signal(s). For one instance, the unit of the time instance can be a symbol, a slot, a ms, a frame, or a DRX cycle.

In yet another example, the explicit signal or channel could further include information on a type of energy saving level the UE can operate with using the LR. For one instance, there can be at least two different energy saving levels predefined in the specification or configured by higher layer, and the explicit signal or channel can include an indication on an index of an energy saving level for the UE to operate with using the LR. For another instance, the explicit signal or channel can include an indication on configuration of an energy saving level for the UE to operate with using the LR.

In one example, if the UE does not receive the explicit signal or channel in one of the reception occasion, the UE may keep using the MR for reception and/or transmission, and/or assume the low power signal(s) is not transmitted/activated.

In another example, if the gNB does not receive the confirmation on the successful reception of explicit signal or channel, the gNB may assume the use of LR by the UE is not triggered or the activation of the low power signal(s) is not triggered. In one further consideration, the gNB may re-transmit the explicit signal or channel.

In yet another example, the gNB may transmit the explicit signal or channel in one or multiple occasions to trigger using the LR or activation/deactivation of the low power signal(s), before transmitting a low-power wake-up-signal.

In one embodiment, the transition from using a MR to using a LR, or initiating the use of the LR, or enabling the MR to operate in a state with low power (e.g., ultra deep sleep), or activation/deactivation of low power signal(s), can be triggered implicitly, e.g., triggered by an implicit trigger.

In one example, the implicit trigger can be used when the explicit trigger or the configuration for the explicit trigger is not provided, or when the explicit trigger is not received.

In one example, if the UE is in RRC_CONNECTED mode, the UE can transit to RRC_IDLE or RRC_INACTIVE mode after the implicit trigger.

In another example, if the UE is in RRC_INACTIVE mode, the UE can transit to RRC_IDLE mode after the implicit trigger.

In one example, the implicit trigger can be based on a timing. The transition from using a MR to using a LR, or initiating the use of the LR, or enabling the MR to operate in a state with low power (e.g., ultra deep sleep), or activation/deactivation of low power signal(s), can be triggered when the particular timing instance arrives. In various examples, the timing can be an OFDM symbol boundary. In other examples, the timing can be a slot boundary. For yet additional examples, the timing can be a frame boundary. For some more examples, the timing can be a DRX cycle boundary.

In another example, the implicit trigger can be based on DRX cycle configuration in RRC_IDLE and/or RRC_INACTIVE mode. In various examples, the implicit trigger can be aligned with: a paging occasion or a monitoring occasion for PEI.

In yet another example, the implicit trigger can be based on DRX cycle configuration in RRC_CONNECTED mode. In various examples, the implicit trigger can be aligned with: an ON duration in a DRX cycle or a boundary of a period for the DRX cycle,

In yet another example, the implicit trigger can be based on reception situation of signal or channel, e.g., using the MR. In some further examples, if the UE (e.g., using MR) misses the reception of a DL signal or channel consecutively for K times, the UE can assume to transit from using a MR to using a LR, or to initiate the use of the LR, or to enable the MR to operate in a state with low power (e.g., ultra deep sleep), or activation of low power signal(s). In such examples, the DL signal or channel can be at least one of SS/PBCH block, PDCCH (e.g., PDCCH of paging, PDCCH of SIB1, or PDCCH of SIBx with x>1), PDSCH (e.g., PDSCH of paging, PDSCH of SIB1, or PDSCH of SIBx with x>1), or DL RS (e.g., TRS, or PRS), or the explicit trigger as described in the disclosure. In such examples, K can be either fixed in the specification, or provided by higher layer parameter, or provided by a DCI format.

In other examples, if the UE (e.g., using MR) receives a LP-WUS or LP-WUS related signal (e.g., the synchronization signal for LR), the UE can assume to transit from using a MR to using a LR, or to initiate the use of the LR, or to enable the MR to operate in a state with low power (e.g., ultra deep sleep), or deactivation/activation of low power signal(s).

For yet another example, the UE (e.g., using MR) does not receive a DL signal or channel for a time duration, the UE can assume: to transit from using a MR to using a LR, to initiate the use of the LR, or to enable the MR to operate in a state with low power (e.g., ultra deep sleep), or activation of low power signal(s). In such examples, the DL signal or channel can be at least one of SS/PBCH block, PDCCH (e.g., PDCCH of paging, PDCCH of SIB1, or PDCCH of SIBx with x>1), PDSCH (e.g., PDSCH of paging, PDSCH of SIB1, or PDSCH of SIBx with x>1), or DL RS (e.g., TRS, or PRS). In such examples, the time duration can be either fixed in the specification, or provided by higher layer parameter, or provided by a DCI format. In such examples, the time duration can be determined with respect to a timing instance, e.g., the reception of SIB1, or SIBx, or SS/PBCH block, or a DL RS, or any DL reception.

In one example, the implicit trigger can be a response to a request on using the LR, wherein the request can be sent from the UE. The request can be included in: a Msg1 of a 4-step RACH procedure (e.g., PRACH); a Msg3 of a 4-step RACH procedure; a MsgA of a 2-step RACH procedure; a scheduling request (SR); a PUCCH; a PUSCH (e.g., CG-PUSCH); and in higher layer parameter, e.g., UE assistant information.

In one example, after the implicit trigger, the UE (e.g., 116) can send back to the gNB (e.g., 102) a confirmation on the use of the LR. The confirmation can be included in: a Msg1 of a 4-step RACH procedure (e.g., PRACH), a Msg3 of a 4-step RACH procedure, a MsgA of a 2-step RACH procedure, a PUCCH (e.g., a PUCCH carrying UCI), a PUSCH (e.g., a PUSCH carrying UCI), a higher layer parameter (e.g., UE assistant information), or a RRC release request. This example may be applicable for RRC_CONNECTED mode.

In another example, if the gNB does not receive the confirmation on the use of the LR, the gNB may assume the use of LR by the UE is not triggered, or the activation of the low power signal(s) is not triggered.

FIG. 6 illustrates a diagram 600 for application delays. The embodiment of the diagram 600 illustrated in FIG. 6 is for illustration only. One or more components illustrated in FIG. 6 can be implemented in specialized circuitry configured to perform the noted functions or one or more of the components can be implemented by one or more processors executing instructions to perform the noted functions. FIG. 6 does not limit the scope of this disclosure to any particular implementation of the example diagram 600 for application delays.

In one embodiment, there can be an application delay for the MR (e.g., such as MR 314) to transit to or to be enabled to operate in a state with low power (e.g., ultra deep sleep) or to be ready for stopping receiving signal/channel other than the low power signal(s) (e.g., the low power signal(s) can be received by the LR (e.g., such as LR 312)).

In one example, the application delay for MR can be 0.

In one example, the application delay is determined using a reference timing as the reception of the trigger (e.g., the starting or ending instance of the explicit signal or channel).

In another example, the application delay is determined using a reference timing as the transmission of the confirmation of the successful reception of the trigger (e.g., explicit signal or channel).

In yet another example, the application delay is determined using a reference timing as the implicit trigger.

In one example, the application delay can be used for the UE to prepare for transition to or being enabled to operate in a state with low power (e.g., ultra deep sleep) such that the UE may not need to receive signal or channel other than the low power signal(s), e.g., preparation time.

In another example, the application delay can be used for the UE to process signal and/or channel in order to transit to or to be enabled to operate in a state with low power (e.g., ultra deep sleep) such that the UE may not need to receive signal or channel other than the low power signal(s), e.g., processing time.

In one example, a maximum value of the application delay or a minimum value of the application delay or the value of the application delay can be determined by the specification, e.g., determined based on a subcarrier spacing.

In another example, a maximum value of the application delay or a minimum value of the application delay or the value of the application delay can be determined based on UE capability.

In yet another example, a maximum value of the application delay or a minimum value of the application delay or the value of the application delay can be provided by the higher layer parameter.

In one example, within the maximum value of the application delay or the minimum value of the application delay or the value of the application delay, the UE is expected to receive and/or transmit signal and/or channel other than the low power signal(s) (e.g., using the MR). The signal and/or channel can be an SS/PBCH block or a PDCCH. The PDCCH can be with a particular type, e.g., Type0-PDCCH, Type0A-PDCCH, Type1-PDCCH, or Type2-PDCCH. Alternatively or additionally, the PDCCH can be any PDCCH monitored in CSS or in USS. The PDCCH may be any PDCCH. The signal and/or channel can also be a PDSCH. For instance, the PDSCH can be scheduled by: a particular type of PDCCH, (e.g., Type0-PDCCH, Type0A-PDCCH, Type1-PDCCH, or Type2-PDCCH), any PDCCH monitored in CSS, any PDCCH monitored in USS, and by any PDCCH. The signal and/or channel can be: a DL RS wherein the DL RS may be TRS or CSI-RS, a PUCCH, a PUSCH, PRACH, and UL RS.

In another example, after the maximum value of the application delay or the minimum value of the application delay or the value of the application delay (e.g., and before the next triggering of the MR or before deactivation of the low power signal(s) or before the associated timer), the UE is not expected to receive and/or transmit signal and/or channel other than the low power signal(s) (e.g., using the MR). The signal and/or channel can be an SS/PBCH block or a PDCCH. The PDCCH can be with a particular type, e.g., Type0-PDCCH, Type0A-PDCCH, Type1-PDCCH, or Type2-PDCCH, any PDCCH monitored in CSS, any PDCCH monitored in USS, or any other PDCCH. The signal and/or channel can be PDSCH. For instance, the PDSCH can be scheduled by a particular type of PDCCH, e.g., Type0-PDCCH, Type0A-PDCCH, Type1-PDCCH, or Type2-PDCCH. For another instance, the PDSCH can be scheduled by any PDCCH monitored in CSS. For yet another instance, the PDSCH can be scheduled by any PDCCH monitored in USS. For yet another instance, the PDSCH can be scheduled by any PDCCH. For yet another sub-example, the signal and/or channel can be DL RS, where in the DL RS can be TRS or CSI-RS. The signal and/or channel can be: a PUCCH, a PUSCH, a PRACH and a UL RS.

In one embodiment, there can be an application delay for the LR to be enabled or for the UE to be ready for receiving low power signal(s) after activation. An illustration is shown in FIG. 5, and the application delay for the LR is denoted as D1_LR.

In one example, the application delay for LR can be 0.

In another example, the application delay for the MR (e.g., D1_MR) can be same as the application delay for the LR (e.g., D1_LR).

In yet another example, the ending instance for the application delay for the MR can be aligned with the ending instance for the application delay for the LR.

In yet another example, the ending instance for the application delay for the MR can be no earlier than (or later than) the ending instance for the application delay for the LR.

In yet another example, the ending instance for the application delay for the MR can be no later than (or earlier than) the ending instance for the application delay for the LR.

In one example, the application delay is determined using a reference timing as the reception of the trigger (e.g., the starting or ending instance of the explicit signal or channel).

In another example, the application delay is determined using a reference timing as the transmission of the confirmation of the successful reception of the trigger (e.g., explicit signal or channel).

In yet another example, the application delay is determined using a reference timing as the implicit trigger.

In one example, the application delay can be used for the UE to prepare for the LR to be enabled such that the UE can receive the low power signal(s), e.g., preparation time.

In another example, the application delay can be used for the UE to process signal and/or channel in order to enable the LR such that the UE can receive the low power signal(s), e.g., processing time.

In one example, a maximum value of the application delay or a minimum value of the application delay or the value of the application delay can be determined by the specification, e.g., determined based on a subcarrier spacing.

In another example, a maximum value of the application delay or a minimum value of the application delay or the value of the application delay can be determined based on UE capability.

In yet another example, a maximum value of the application delay or a minimum value of the application delay or the value of the application delay can be provided by the higher layer parameter.

In one example, after the maximum value of the application delay or the minimum value of the application delay or the value of the application delay (e.g., and before the next triggering of the MR or before deactivation of the low power signal(s) or before the associated timer), the UE is expected to receive and/or transmit signal and/or channel (e.g., low power signal), e.g., using the LR. The signal and/or channel can be a low power wake-up-signal (LP-WUS) or part of the LP-WUS or the signal and/or channel can be a synchronization signal received by the LR (LP-SS), e.g., to enable synchronization between the gNB and the LR.

In another example, within the maximum value of the application delay or the minimum value of the application delay or the value of the application delay, the UE is not expected to receive and/or transmit signal and/or channel (e.g., low power signal), e.g., using the LR. The signal and/or channel can be a low power wake-up-signal (LP-WUS) or part of the LP-WUS or the signal and/or channel can be a synchronization signal received by the LR (LP-SS), e.g., to enable synchronization between the gNB and the LR.

In one embodiment, the measurement procedure, including at least one of RRM, RLM, BM, BFR, can be determined based on the application delay(s).

In one example, the measurement procedure is applicable for RRC_IDLE and/or RRC_CONNECTED state.

In one example, within the maximum value of the application delay or the minimum value of the application delay or the value of the application delay for the MR, the UE is expected to perform measurement based on signal other than the low power signal(s), e.g., using the MR. In further examples, the measurement can be based on SS/PBCH block or can be based on CSI-RS.

In another example, after the maximum value of the application delay or the minimum value of the application delay or the value of the application delay for the MR (e.g., and before the next triggering of the MR or before deactivation of the low power signal(s) or before the associated timer), the UE is not expected to perform measurement based on signal other than the low power signal(s), e.g., using the MR. In further examples, the measurement can be based on SS/PBCH block or can be based on CSI-RS.

In yet another example, within the maximum value of the application delay or the minimum value of the application delay or the value of the application delay for the LR, the UE is not expected to perform measurement based on the low power signal(s), e.g., using the LR. In additional examples, the measurement can be based on LP-WUS or part of the LP-WUS or can be based on synchronization signal received by the LR (LP-SS), e.g., to enable synchronization between the gNB and the LR.

In yet another example, after the maximum value of the application delay or the minimum value of the application delay or the value of the application delay for the LR (e.g., and before the next triggering of the MR or before deactivation of the low power signal(s) or before the associated timer), the UE is expected to perform measurement based on the low power signal(s), e.g., using the LR. For some examples, the measurement can be based on LP-WUS or part of the LP-WUS or based on a synchronization signal received by the LR (LP-SS), e.g., to enable synchronization between the gNB and the LR.

In one example, if a time duration is included in the application delay for the LR and not included in the application delay for the MR (e.g., when D1_LR > D1_MR), the UE does not expect to perform measurement based on RS located in the time duration. For instance, the measurement requirement can be relaxed based on the time duration.

In another example, if a time duration is included in the application delay for the MR and not included in the application delay for the LR (e.g., when D1_LR < D1_MR), the UE can perform measurement based on at least one RS from the MR or one RS from the LR. In more examples, the measurement can be performed using either one of the RS from the MR (e.g., SS/PBCH block and/or CSI-RS) or the RS from the LR (e.g., LP-WUS or LP-SS), e.g., either instance from the measurement can be used for calculating the L1 RSRP or L3 RSRP. In additional examples, the measurement can be performed using both of the RS from the MR (e.g., SS/PBCH block and/or CSI-RS) and the RS from the LR (e.g., LP-WUS or LP-SS), e.g., both instances from the measurement can be used for calculating the L1 RSRP or L3 RSRP.

In one embodiment, an application delay can be extended based on UE’s reception of a signal and/or channel. For one example, the application delay for the MR and/or the application delay for the LR can be extended if the UE receives a PDCCH.

In further examples, the application delay can be: recounted/reset at the timing of receiving the PDCCH (e.g., the timer for application delay can be restarted); extended for a predefined value at the timing of receiving the PDCCH; extended for a value at the timing of receiving the PDCCH, wherein the value can be provided by the higher layer; and extended for a value at the timing of receiving the PDCCH, wherein the value can be provided by a DCI format. For instance, the DCI format can be carried by the received PDCCH. For yet another example, the PDCCH can be a PDCCH scheduling a PDSCH including user data. For instance, the PDCCH can carry a DCI format 1_1 and/or DCI format 1_2. For other examples, the PDCCH can be a PDCCH scheduling a PUSCH including user data. For instance, the PDCCH can carry a DCI format 0_1 and/or DCI format 0_2.

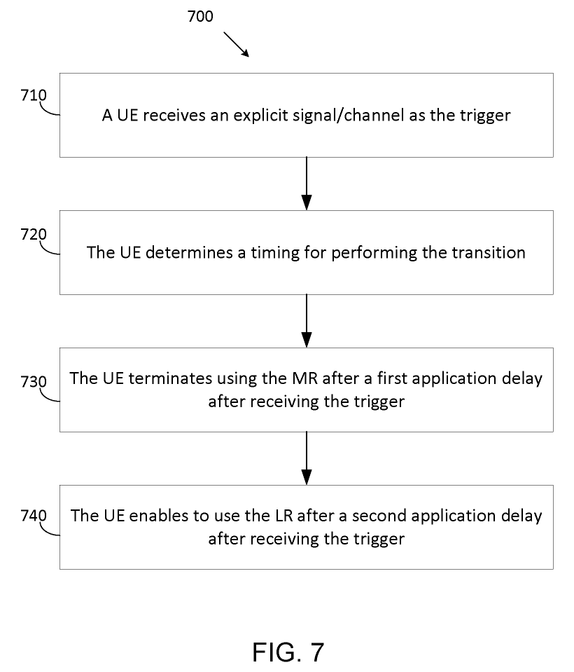

FIG. 7 illustrates a flowchart of a method 700 for a UE to trigger a LR. The embodiment of the method 700 illustrated in FIG. 7 is for illustration only. One or more steps illustrated in FIG. 7 can be implemented in specialized circuitry configured to perform the noted functions or one or more of the steps can be implemented by one or more processors executing instructions to perform the noted functions. FIG. 7 does not limit the scope of this disclosure to any particular implementation of the method 700.

At step 710, a UE (e.g., 116) receives an explicit signal/channel as the trigger. At step 720, the UE determines a timing for performing the transition. At step 730, the UE terminates using the MR after a first application delay after receiving the trigger. At step 740, the UE is enabled to use the LR after a second application delay after receiving the trigger.

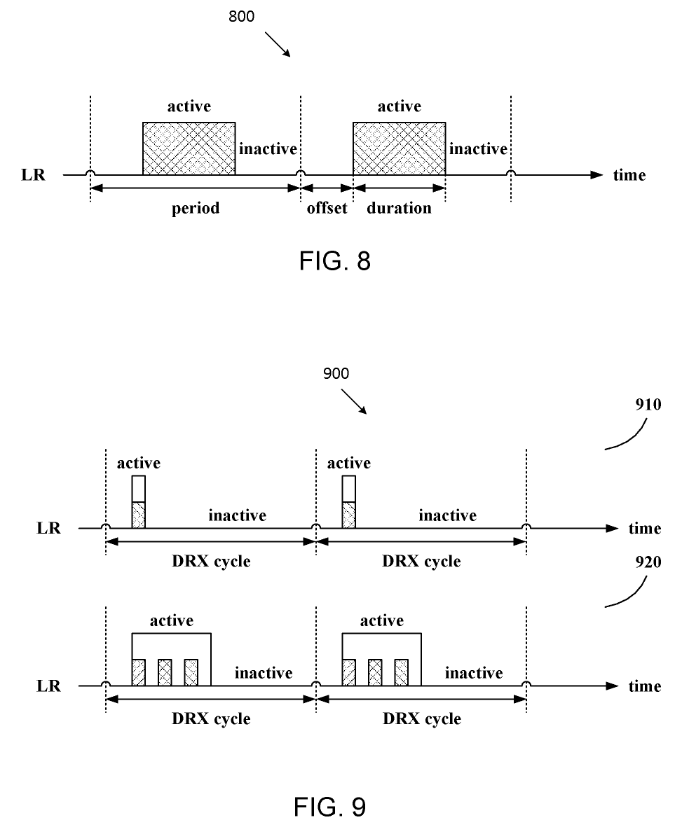

FIG. 8 illustrates a diagram 800 of DRX for a LR. The embodiment of the diagram 800 illustrated in FIG. 8 is for illustration only. One or more components illustrated in FIG. 8 can be implemented in specialized circuitry configured to perform the noted functions or one or more of the components can be implemented by one or more processors executing instructions to perform the noted functions. FIG. 8 does not limit the scope of this disclosure to any particular implementation of the diagram 800.

In one embodiment, a DRX can be supported for the LR (e.g., such as LR 312), which can be denoted as LR-DRX. For instance, the discontinuous reception is for a signal or channel that can be received by the LR, such as LP-WUS and/or LP-SS. For another instance, in the remaining of this disclosure, if not explicitly mentioned, the DRX refers to LR-DRX.

In one example, a set of configurations for the DRX can be provided to the UE.

In an example, the set of configurations for the DRX can be received by the MR (e.g., such as MR 314).

In one example, the set of configurations for DRX or part of the set of configurations for DRX can be provided to the UE by system information block 1 (SIB1).

In another example, the set of configurations for DRX or part of the set of configurations for DRX can be provided to the UE by system information block x (SIBx), wherein x>1.

In yet another example, the set of configurations for DRX or part of the set of configurations for DRX can be provided to the UE by paging message (e.g., carried by the paging PDSCH).

In further examples, the set of configurations for DRX or part of the set of configurations for DRX can be provided to the UE by paging short message (e.g., carried by the paging PDCCH).

In other examples, the set of configurations for DRX or part of the set of configurations for DRX can be provided to the UE by dedicated RRC signaling (e.g., UE-specific RRC signaling).

In examples, the set of configurations for DRX or part of the set of configurations for DRX can be fixed in the specification.

In some examples, the set of configurations can include a period, such that the active portion and/or the inactive portion of the DRX cycle periodically occurs in the time domain with respect to the period. For instance, the start of a period can be aligned with a system frame, e.g., potentially with further condition on its number.

In additional examples, the set of configurations can include an offset, e.g., defined based on a reference timing. For one instance, the offset can be between the start of an active portion of the DRX cycle and the start of the period. For another instance, the offset can be between an active portion of the DRX cycle and a paging occasion. For yet another instance, the offset can be between an active portion of the DRX cycle and a monitoring occasion for PEI. For yet another instance, the offset can be between an active portion of the DRX cycle and a ON duration of a DRX cycle. For yet another instance, the offset can be between the active portion of the LR-DRX cycle and active portion of the MR-DRX cycle.

In yet another example, the set of configurations can include a duration, e.g., a duration of the active portion of the DRX cycle or a duration of the inactive portion of the DRX cycle. For one instance, the terminology of active portion of the DRX cycle can be referred to as other equivalent terminologies, such as ON duration of the DRX cycle. For another instance, the terminology of inactive portion of the DRX cycle can be referred to as other equivalent terminologies, such as OFF duration of the DRX cycle, or non-active portion of the DRX cycle.

In one example, the set of configurations for LR-DRX can be complied with the configuration for synchronization signals to be received by the LR (e.g., denoted by LP-SS). For instance, the transmission occasions for LP-SS can be within the active portions of the DRX cycles. For another instance, the periodicity of the LP-SS can be an integer multiple of the periodicity of the DRX cycle. For yet another instance, the duration of the active portion of the DRX cycle can be equal to or larger than a duration of the LP-SS.

In one example, the set of configurations for LR-DRX can be complied with the configuration for wake-up-signal to be received by the LR (e.g., denoted by LP-WUS) or a portion of the LP-WUS. For instance, the transmission occasions for LP-WUS or a portion of the LP-WUS can be within the active portions of the DRX cycles. For another instance, the periodicity of the LP-WUS or a portion of the LP-WUS can be an integer multiple of the periodicity of the DRX cycle. For yet another instance, the duration of the active portion of the DRX cycle can be equal to or larger than a duration of the LP-WUS or a portion of the LP-WUS.

In one example, the set of configurations for LR-DRX can be complied with the configuration for DRX on MR (MR-DRX). For one instance, the active portions of DRX cycles in LR-DRX can be within active portions of DRX cycles in MR-DRX (e.g., ON duration for MR-DRX in RRC_CONNECTED mode, and/or active duration for MR-DRX in RRC_IDLE/INACTIVE mode). For another instance, the periodicity for LP-DRX can be an integer multiple of the periodicity for MR-DRX (e.g., MR-DRX in CONNECTED mode and/or MR-DRX in RRC_IDLE/INACTIVE mode). For yet another instance, the duration of the active portion for DRX cycle in LP-DRX can be equal to or smaller than the duration of the active portion for DRX cycle in MR-DRX (e.g., ON duration for MR-DRX in RRC_CONNECTED mode, and/or active duration for MR-DRX in RRC_IDLE/INACTIVE mode).

In one example, there can be at least two LR-DRXs, and each LR-DRX is associated with a set of configurations for the LR-DRX. For one instance, a first LR-DRX can be associated with the LP-SS, and a second LR-DRX can be associated with the LP-WUS (or a portion of the LP-WUS). For another instance, a first LR-DRX can be associated with a first portion of the LP-WUS, and a second LR-DRX can be associated with a second portion of the LP-WUS. For yet another instance, a first LR-DRX can be associated with a first LP-WUS, and a second LR-DRX can be associated with a second LP-WUS. For yet another instance, the at least two sets of configurations for the two LR-DRXs can include common configurations, e.g., the period, and/or the offset, and/or the duration can be common for the at least two LR-DRXs.

In one embodiment, a UE can try to receive at least one of a LP-SS, or a LP-WUS, or a portion of a LP-WUS, based on the LR-DRX. A reception occasion of a signal or channel in this disclosure refers to time and/or frequency resource(s) allocated for the signal or channel for one reception.

In one example, the LR-DRX can be applicable for both LR-SS and LP-WUS (or a portion of the LP-WUS). For instance, the reception occasions of LP-SS and LP-WUS (or a portion of the LP-WUS) are located in the active portion of the DRX cycle for LR-DRX. In another example, the LR-DRX can be applicable for both a first portion and a second portion of the LP-WUS. For instance, the reception occasions of the first portion and the second portion of the LP-WUS are located in the active portion of the DRX cycle for LR-DRX. In yet another example, the LR-DRX can be applicable for LR-SS only, and the reception of LP-WUS (or a portion of the LP-WUS) may not be based on the LR-DRX. For instance, the reception occasion of LP-WUS (or a portion of the LP-WUS) can be located in the inactive portion of the DRX cycle for LR-DRX. In yet another example, the LR-DRX can be applicable for LP-WUS (or a portion of the LP-WUS) only, and the reception of LP-SS may not be based on the LR-DRX. For instance, the reception occasion of LP-SS can be located in the inactive portion of the DRX cycle for LR-DRX. In yet another example, the LR-DRX can be applicable for a first portion of the LP-WUS only, and the reception of a second portion of the LP-WUS may not be based on the LR-DRX. For instance, the reception occasion of the second portion of the LP-WUS can be located in the inactive portion of the DRX cycle for LR-DRX.

FIG. 9 illustrates a diagram 900 of a UE reception in a DRX cycle. The embodiment of the diagram 900 illustrated in FIG. 9 is for illustration only. One or more components illustrated in FIG. 9 can be implemented in specialized circuitry configured to perform the noted functions or one or more of the components can be implemented by one or more processors executing instructions to perform the noted functions. FIG. 9 does not limit the scope of this disclosure to any particular implementation of the diagram 900 of a UE reception in a DRX cycle.

In example reception 910, in each active portion of the DRX cycle in a LR-DRX, there can be a single time domain reception occasion for at least one of a LP-SS, or a LP-WUS, or a portion of a LP-WUS, based on the LR-DRX. The time domain reception occasion can be aligned with the active portion of the DRX cycle. For instance, the starting instance of the time domain reception occasion can be aligned with the starting instance of the active portion of the DRX cycle. For another instance, the duration of the time domain reception occasion can be aligned with the duration of the active portion of the DRX cycle. For yet another instance, the periodicity of the time domain reception occasion can be equal to the periodicity of the DRX cycle. The time domain reception occasion can be same as the active portion of the DRX cycle, and there can be no explicit definition of DRX cycle.

In example reception 920, in each active portion of the DRX cycle in a LR-DRX, there can be one or multiple time domain reception occasions for at least one of a LP-SS, or a LP-WUS, or a portion of a LP-WUS, based on the LR-DRX.

In one example, the one or multiple time domain reception occasions can be consecutive in the time domain (e.g., no gap in between neighboring reception occasions). For instance, the starting instance of the first time domain reception occasion can be aligned with the starting instance of the active portion of the DRX cycle. For instance, the ending instance of the last time domain reception occasion can be aligned with the ending instance of the active portion of the DRX cycle. For yet another instance, the duration of all the time domain reception occasions can be aligned with the duration of the active portion of the DRX cycle. For yet another instance, the periodicity of the time domain reception occasions can be equal to the periodicity of the DRX cycle.

In another example, there can be a uniform gap among the one or multiple time domain reception occasions. For one instance, the duration of the gap can be predetermined in the specification. For another instance, the duration of the gap can be provided by higher layer parameter.

In yet another example, the locations of the one or multiple time domain reception occasions can be provided based on higher layer parameters. For one instance, the locations can be determined at least based on an offset between the first reception occasion and the starting instance of the active portion, wherein, e.g., the offset can be provided by higher layer. For another instance, the locations can be determined at least based on an interval between neighboring reception occasions, wherein, e.g., the interval can be provided by higher layer. For yet another instance, the locations can be determined at least based on a number of reception occasions, wherein, e.g., the number can be provided by higher layer, or determined based on a number of SS/PBCH blocks (such as number of actually transmitted SS/PBCH blocks in a half frame).

In one example, the reception occasions for LP-SS can be different from the reception occasions for LP-WUS (or a portion of the LP-WUS). For this example, a first example or sub-example in this embodiment can be applicable for the reception occasions for LP-SS, and a second example or sub-example in this embodiment can be applicable for the reception occasions for LP-WUS (or a portion of the LP-WUS).

In another example, the reception occasions for a first portion of the LP-WUS can be different from the reception occasions for a second portion of the LP-WUS. For this example, a first example or sub-example in this embodiment can be applicable for the reception occasions for the first portion of the LP-WUS, and a second example or sub-example in this embodiment can be applicable for the reception occasions for the second portion of the LP-WUS.

In one example, a UE does not expect a reception occasion for LP-SS and a reception occasion for LP-WUS (or a portion of the LP-WUS) overlap (or partially overlap).

In another example, if a reception occasion for LP-SS and a reception occasion for LP-WUS (or a portion of the LP-WUS) overlap (or partially overlap), the UE can drop the reception of LP-SS and try to receive LP-WUS (or a portion of the LP-WUS).

In yet another example, if a reception occasion for LP-SS and a reception occasion for LP-WUS (or a portion of the LP-WUS) overlap (or partially overlap), the UE can drop the reception of LP-WUS (or a portion of the LP-WUS) and try to receive LP-SS.

In yet another example, if a reception occasion for LP-SS and a reception occasion for LP-WUS (or a portion of the LP-WUS) overlap (or partially overlap), the UE can drop the reception of the signal whose reception occasion takes place with a later time instance, and try to receive the signal whose reception occasion takes place with an earlier time instance.

In one example, a UE does not expect a reception occasion for a first portion of LP-WUS and a reception occasion for a second portion of LP-WUS overlap (or partially overlap).

In another example, if a reception occasion for a first portion of LP-WUS and a reception occasion for a second portion of LP-WUS overlap (or partially overlap), the UE can drop the reception of the first portion of LP-WUS and try to receive the second portion of LP-WUS.

In yet another example, if a reception occasion for a first portion of LP-WUS and a reception occasion for a second portion of LP-WUS overlap (or partially overlap), the UE can drop the reception of the second portion of LP-WUS and try to receive the first portion of LP-WUS.

In yet another example, if a reception occasion for a first portion of LP-WUS and a reception occasion for a second portion of LP-WUS overlap (or partially overlap), the UE can drop the reception of the signal whose reception occasion takes place with a later time instance, and try to receive the signal whose reception occasion takes place with an earlier time instance.

In one example, for RRC_IDLE and/or RRC_INACTIVE mode, a reception occasion for LP-SS and/or LP-WUS can be associated with a MR-DRX cycle, such that the reception occasion can be associated with a set of paging occasions and/or PEI monitoring occasions in the MR-DRX cycle.

In another example, for RRC_CONNECTED mode, a reception occasion for LP-SS and/or LP-WUS can be associated with a MR-DRX cycle, such that the reception occasion can be associated with a ON duration within the MR-DRX cycle.

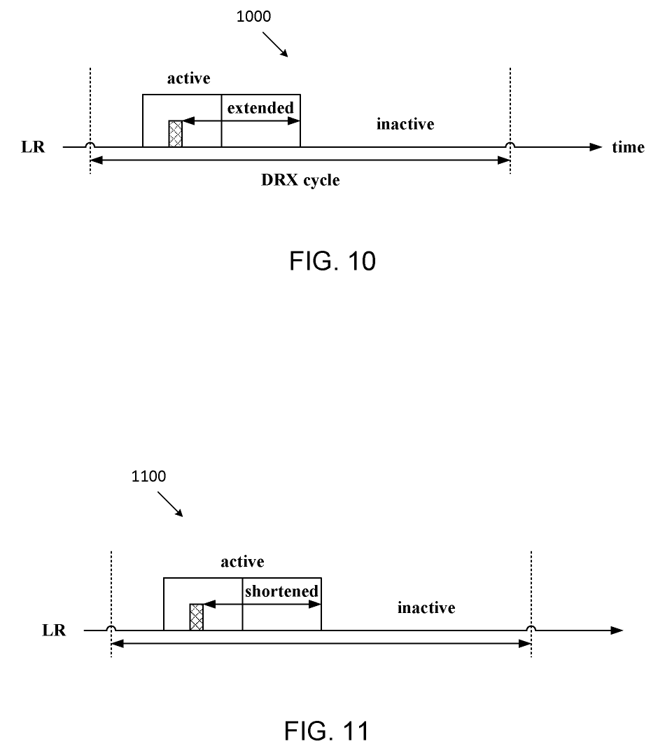

FIG. 10 illustrates a diagram 1000 for extending the active portion of a DRX cycle. The embodiment of the diagram 1000 illustrated in FIG. 10 is for illustration only. One or more components illustrated in FIG. 10 can be implemented in specialized circuitry configured to perform the noted functions or one or more of the components can be implemented by one or more processors executing instructions to perform the noted functions. FIG. 10 does not limit the scope of this disclosure to any particular implementation of the diagram 1000 for extending the active portion of a DRX cycle.

In one embodiment, an active portion of a DRX cycle for LR-DRX can be extended based on UE’s reception status using the LR.

In one example, the extension of the active portion of a DRX cycle can be triggered if the UE receives a LP-SS, e.g., in a reception occasion for LP-SS within the active portion of the DRX cycle.

In another example, the extension of the active portion of a DRX cycle can be triggered if the UE receives a LP-WUS, e.g., in a reception occasion for LP-WUS within the active portion of the DRX cycle. In yet another example, the extension of the active portion of a DRX cycle can be triggered if the UE receives a first portion of the LP-WUS, e.g., in a reception occasion for the first portion of the LP-WUS within the active portion of the DRX cycle.

In one example, the duration for the extension of the active portion of a DRX cycle can be predefined in the specification. In another example, the duration for the extension of the active portion of a DRX cycle can be provided by higher layer parameter. In yet another example, the duration for the extension of the active portion of a DRX cycle can be determined based on the configuration of reception occasion. For instance, the duration can be determined as one or multiple intervals for the reception occasions. For another instance, the duration can be determined as the time difference between the trigger for the extension and the next reception occasion for the LP-SS, or LP-WUS, or a portion of the LP-WUS. The duration can be a time difference between the trigger for the extension and the next reception occasion for LP-WUS, wherein the trigger is a reception of LP-SS. In other examples, the duration can be a time difference between the trigger for the extension and the next reception occasion for the second portion of the LP-WUS, wherein the trigger is a reception of the first portion of the LP-WUS.

In yet another example, the duration for the extension of the active portion of a DRX cycle can be provided in the trigger for the extension (e.g., as described in the disclosure).

In one example, the reference time instance to start the extension can be determined as the starting instance of the reception occasion where the trigger for the extension is received.

In another example, the reference time instance to start the extension can be determined as the ending instance of the reception occasion where the trigger for the extension is received.

In yet another example, the reference time instance to start the extension can be determined as the starting instance of a slot (or the first slot if the reception occasion is included in multiple slots) that includes or overlaps with the reception occasion where the trigger for the extension is received.

In further examples, the reference time instance to start the extension can be determined as the ending instance of a slot (or the latest slot if the reception occasion is included in multiple slots) that includes or overlaps with the reception occasion where the trigger for the extension is received.

In yet another example, the reference time instance to start the extension can be determined as the starting instance of an OFDM symbol (or the first OFDM symbol if the reception occasion is included in multiple OFDM symbols) that includes or overlaps with the reception occasion where the trigger for the extension is received.

In other examples, the reference time instance to start the extension can be determined as the ending instance of an OFDM symbol (or the latest OFDM symbol if the reception occasion is included in multiple OFDM symbols) that includes or overlaps with the reception occasion where the trigger for the extension is received.

In some examples, the reference time instance to start the extension can be determined as the ending instance of the active portion of the DRX cycle (e.g., the active portion before extension).

In one example, the UE assumes the ending instance of the active portion of the DRX cycle after the extension is the later time instance between the ending instance of the active portion of the DRX cycle before extension and the time instance that the extension is extended to (e.g., according to the example of this disclosure).

In another example, the UE assumes the ending instance of the active portion of the DRX cycle after the extension may not exceed the ending instance of the corresponding DRX cycle. If the determined ending instance of the active portion of the DRX cycle after the extension exceeds the ending instance of the corresponding DRX cycle, the UE truncates the active portion such that the ending instance of the active portion is aligned with the ending instance of the corresponding DRX cycle.

FIG. 11 illustrates a diagram 1100 for shortening the active portion of a DRX cycle. The embodiment of the diagram 1100 illustrated in FIG. 11 is for illustration only. One or more components illustrated in FIG. 11 can be implemented in specialized circuitry configured to perform the noted functions or one or more of the components can be implemented by one or more processors executing instructions to perform the noted functions. FIG. 11 does not limit the scope of this disclosure to any particular implementation of the diagram 1100 for shortening the active portion of a DRX cycle.

In one example, the shortening of the active portion of a DRX cycle can be triggered if the UE receives a LP-SS, e.g., in a reception occasion for LP-SS within the active portion of the DRX cycle.

In another example, the shortening of the active portion of a DRX cycle can be triggered if the UE receives a LP-WUS, e.g., in a reception occasion for LP-WUS within the active portion of the DRX cycle.

In yet another example, the shortening of the active portion of a DRX cycle can be triggered if the UE receives a first portion of the LP-WUS, e.g., in a reception occasion for the first portion of the LP-WUS within the active portion of the DRX cycle.

In one example, the duration for the shortening of the active portion of a DRX cycle can be predefined in the specification.

In another example, the duration for the shortening of the active portion of a DRX cycle can be provided by higher layer parameter.

In yet another example, the duration for the shortening of the active portion of a DRX cycle can be determined based on the configuration of reception occasion. For instance, the duration can be determined as one or multiple intervals for the reception occasions.

In yet another example, the duration for the shortening of the active portion of a DRX cycle can be provided in the trigger for the shortening (e.g., as described in the disclosure).

In yet another example, the duration for the shortening of the active portion of a DRX cycle can be the remaining duration of the active portion of the DRX cycle after reception of the trigger for the shortening.

In one example, the reference time instance to start the shortening can be determined as the starting instance of the reception occasion where the trigger for the shortening is received.

In another example, the reference time instance to start the shortening can be determined as the ending instance of the reception occasion where the trigger for the shortening is received.

In yet another example, the reference time instance to start the shortening can be determined as the starting instance of a slot (or the first slot if the reception occasion is included in multiple slots) that includes or overlaps with the reception occasion where the trigger for the shortening is received.

In yet another example, the reference time instance to start the shortening can be determined as the ending instance of a slot (or the latest slot if the reception occasion is included in multiple slots) that includes or overlaps with the reception occasion where the trigger for the shortening is received.

In yet another example, the reference time instance to start the shortening can be determined as the starting instance of an OFDM symbol (or the first OFDM symbol if the reception occasion is included in multiple OFDM symbols) that includes or overlaps with the reception occasion where the trigger for the shortening is received.

In yet another example, the reference time instance to start the shortening can be determined as the ending instance of an OFDM symbol (or the latest OFDM symbol if the reception occasion is included in multiple OFDM symbols) that includes or overlaps with the reception occasion where the trigger for the shortening is received.

In yet another example, the reference time instance to start the shortening can be determined as the ending instance of the active portion of the DRX cycle (e.g., the active portion before shortening).

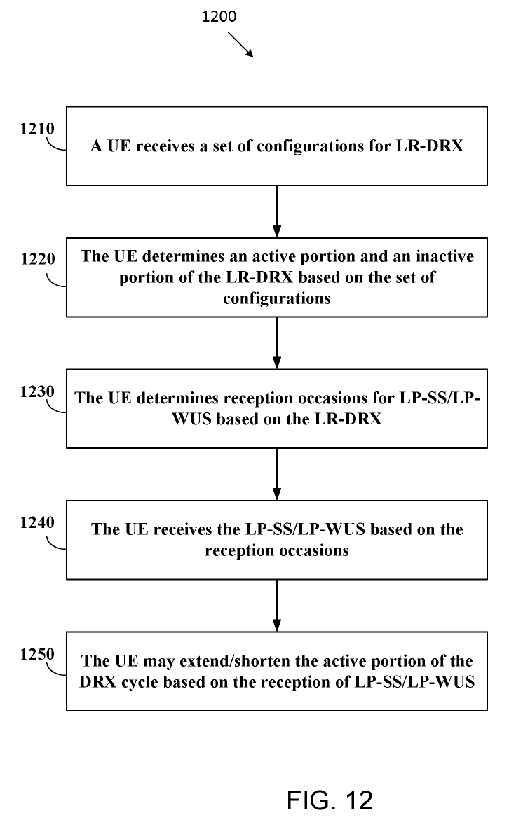

FIG. 12 illustrates a flowchart of a method 1200 for a UE procedure based on LR-DRX. The embodiment of the diagram 1200 illustrated in FIG. 12 is for illustration only. One or more components illustrated in FIG. 12 can be implemented in specialized circuitry configured to perform the noted functions or one or more of the components can be implemented by one or more processors executing instructions to perform the noted functions. FIG. 12 does not limit the scope of this disclosure to any particular implementation of the example method 1200.

At 1210, a UE (e.g., 116) receives a set of configurations for LR-DRX. At 1220, the UE determines an active portion and an inactive portion of the LR-DRX based on the set of configurations. At 1230, the UE determines reception occasions for LP-SS.LP-WUS based on the LR-DRX. At 1240, the UE receives the LP-SS/LP-WUS based on the reception occasions. At 1250, the UE may extend or shorten the active portion of the DRX cycle based on the reception of LP-SS/LP-WUS.

Any of the above variation embodiments can be utilized independently or in combination with at least one other variation embodiment.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A method performed by a user equipment (UE) in a wireless communication system, the method comprising:
receiving, from a base station via a radio resource control (RRC) signaling, configuring information;
determining one or more wakeup signal (WUS) monitoring occasions per periodicity based on the configuring information;
receiving, from the base station, a WUS in an RRC connected state based on the one or more WUS monitoring occasions; and
receiving, from the base station, a system information block 1 (SIB1) including a discontinuous reception (DRX) cycle and an offset for a first WUS monitoring occasion of the one or more WUS monitoring occasions,
wherein a periodicity for the one or more WUS monitoring occasions is equal to the DRX cycle, and
wherein the offset relates to a reference frame of the first WUS monitoring occasion.

2. The method of claim 1, wherein the configuring information includes at least one of a periodicity for the one or more WUS monitoring occasions, a time offset for a first WUS monitoring occasion from the one or more WUS monitoring occasions, and a number of the one or more WUS monitoring occasions per periodicity.

3. The method of claim 1, further comprising, when available symbols in a second WUS monitoring occasion include a symbol for low power synchronization signal (LPSS) reception, omitting monitoring based on the second WUS monitoring occasion in an RRC inactive state or an RRC idle state.

4. A user equipment (UE) in a wireless communication system, the UE comprising:
a transceiver configured to receive, from a base station via a radio resource control (RRC) signaling, configuring information; and
a processor configured to determine one or more wakeup signal (WUS) monitoring occasions per periodicity based on the configuring information,
wherein the transceiver is further configured to:
receive, from the base station, a WUS in an RRC connected state based on the one or more WUS monitoring occasions; and
receive, from the base station, a system information block 1 (SIB1) including a discontinuous reception (DRX) cycle and an offset for a first WUS monitoring occasion of the one or more WUS monitoring occasions,
wherein a periodicity for the one or more WUS monitoring occasions is equal to the DRX cycle, and
wherein the offset relates to a reference frame of the first WUS monitoring occasion.

5. The UE of claim 4, wherein the configuring information includes at least one of a periodicity for the one or more WUS monitoring occasions, a time offset for a first WUS monitoring occasion from the one or more WUS monitoring occasions, and a number of the one or more WUS monitoring occasions per periodicity.

6. The UE of claim 4, wherein the processor is further configured to, when available symbols in a second WUS monitoring occasion include a symbol for low power synchronization signal (LPSS) reception, omit monitoring based on the second WUS monitoring occasion in an RRC inactive state or an RRC idle state.

7. A base station in a wireless communication system, the base station comprising:
a transceiver configured to transmit, to a user equipment (UE) via a radio resource control (RRC) signaling, configuring information; and
a processor configured to determine one or more wakeup signal (WUS) monitoring occasions per periodicity based on the configuring information,
wherein the transceiver is further configured to:
transmit, to the UE, a WUS in an RRC connected state based on the one or more WUS monitoring occasions; and
transmit, to the UE, a system information block 1 (SIB1) including a discontinuous reception (DRX) cycle and an offset for a first WUS monitoring occasion of the one or more WUS monitoring occasions,
wherein a periodicity for the one or more WUS monitoring occasions is equal to the DRX cycle, and
wherein the offset relates to a reference frame of the first WUS monitoring occasion.

8. The base station of claim 7, wherein the configuring information includes at least one of a periodicity for the one or more WUS monitoring occasions, a time offset for a first WUS monitoring occasion from the one or more WUS monitoring occasions, and a number of the one or more WUS monitoring occasions per periodicity.

9. The base station of claim 7, wherein, when available symbols in a second WUS monitoring occasion include a symbol for low power synchronization signal (LPSS) reception, monitoring is omitted based on the second WUS monitoring occasion when the UE is in an RRC inactive state or an RRC idle state.
